(19) United States
(12) Patent Application Publication
(10) Pub. No.: US 2008/0093476 A1
(43) Pub. Date: Apr. 24, 2008

(54) Modular Sprayer

(76) Inventors: Kaj A. Johnson, Oakland, CA (US); Ricardo Ruiz de Gopegui, Oakland, CA (US); Marcus Wang, Oakland, CA (US)

Correspondence Address: THE CLOROX COMPANY, P.O. BOX 24305, OAKLAND, CA, 94623-1305, US

(21) Appl. No.: 11/957,732

(22) Filed: Dec. 17, 2007

Related U.S. Application Data
(62) Division of application No. 11/167,438, filed on Jun. 27, 2005.

(51) Int. Cl. B05B 15/00; B05B 15/06; B67D 5/08

(52) U.S. Cl. 239/72; 239/71

(57) ABSTRACT

A liquid sprayer which may be removably attached to a liquid reservoir and thus readily interchangeable with a variety of liquid reservoirs. The sprayer includes a discharge nozzle, a manually or electrically powered pump and an actuation mechanism for the pump. The sprayer includes a quick-release coupling means for attaching the sprayer to a complementary quick-release coupling means fitted to the product reservoir. In some embodiments of the present invention, a signaling means on the reservoir communicates with a corresponding receiver means on the sprayer to provide information relating to the liquid contents of the reservoir so that the user will act on the information in a way that optimizes product safety, efficacy, convenience or combinations thereof. The information concerning the liquid may be conveyed to the user/consumer via the sprayer such that the user/consumer is part of the information/feedback loop, or the information may be communicated to the sprayer, which directly acts on the information without input from the consumer.

### BACKGROUND OF THE INVENTION

1. Field of the Invention

The present invention relates generally to liquid dispensers, especially to pump sprayers of the type having a spray head removably attachable to a liquid-filled reservoir, and more particularly to a liquid dispenser system having a sprayer component which is readily interchangeable with more than one liquid reservoir.

2. Description of Related Art

Trigger spray devices are well-known for their ability to dispense liquids as a fine mist, coarse mist, stream or spray, and have a wide variety of consumer use applications. For example, Formula 409®, a household all-surface cleaning product of The Clorox Company, is sold as a package comprising a product reservoir to which a manually-activated sprayer is attached. Such sprayers are typically manually actuated, but recently sprayers incorporating battery powered, motor-driven pumps have been marketed.

Many consumer products are integrally packaged as a bottle (or reservoir) containing the product, and attached manually-actuated trigger spray head. Such products are not intended for reuse. The consumer may simply discard the empty container and sprayer after use, or preferably, the components are recycled. The Clorox Company, as owner by assignment of the present invention, encourages both re-use and recycling. Other consumer products packaged with integral trigger spray devices are intended to be partially reused, by replacing the spray head assembly and attached dip tube onto a fresh reservoir of product. Reusing traditional trigger spray devices can be awkward and messy, necessitating removal of the spray unit comprising the cap, dip tube, handle, trigger, and spray head body. Because the trigger spray head, especially a motorized trigger spray head, represents a significant portion of the cost of the entire trigger sprayer unit, it would be advantageous to the consumer to be able to easily change the trigger spray head from one product reservoir to another.

Hand-held and hand-operated liquid sprayers commonly known as trigger sprayers are well known in the liquid sprayer art. A typical trigger sprayer is comprised of a sprayer housing, connected to a neck of the liquid-containing bottle by a threaded or similar connection. Such a sprayer is secured by aligning a collar on the sprayer housing with the bottle threads, and manually rotating the collar until secure. The sprayer housing is formed with a pump chamber, a vent chamber, a liquid discharge passage communicating with the pump chamber, a discharge nozzle and orifice, and a liquid supply passage comprising a dip tube communicating with the pump. The dip tube extends into the bottle and the liquid therein when the trigger sprayer housing is attached to the bottle neck. Liquids, for example, those used for cleaning, sanitizing, disinfecting or improving aesthetics, are dispensed in a stream pattern, a spray pattern, or as a foam.

U.S. Pat. No. 6,560,806 to Lawson et al. describes a portable electrical sprayer with a telescoping nozzle. The nozzle is optionally detachable so that the user can selectively chose the spray pattern relative to the surface to clean. U.S. Pat. No. 6,554,211 to Prueter et al. and U.S. Pat. App. 2002/0011531 to DiMaggio et al. describe a standard battery-operated sprayer with an integrated conventional container closure and a conventional inlet tube. U.S. Pat. App. 2004/0099751 to Krestine et al. describes a standard battery-operated sprayer with a battery pack in the sprayer body.

U.S. Pat. No. 6,644,564 to Perkitny et al. and PCT App. WO01/92723 to Sever disclose motorized sprayers with a fully integrated spray head and product reservoir. PCT App. WO01/10563 to Lawson et al. describes several fitment systems for fitting a reservoir to a spray device.

A battery operated trigger sprayer design is described in U.S. Pat. No. 5,716,007 to Nottingham et al. This dispenser includes a reservoir and replaceable power spray head. The dispenser of Nottingham et al, however, requires a uniquely-shaped dispenser, which can complicate the mass manufacture thereof. Moreover, the pump mechanism is built-in to the reservoir, thus when empty, the reservoir, together with the pump mechanism, is discarded.

Manual trigger sprayer designs are disclosed in U.S. Pat. No. 6,715,698 to Foster et al., U.S. Pat. No. 6,669,058 to Sweeton, U.S. Pat. No. 6,659,369 to Forster et al., U.S. Pat. No. 6,641,003 to Foster et al., U.S. Pat. No. 6,446,882 to Dukes et al., U.S. Pat. No. 6,286,723 to Sweeton et al., U.S. Pat. No. 6,131,820 to Dodd, U.S. Pat. No. 5,884,845 to Nelson, and U.S. Pat. App. 2004/0129837 to Foster.

U.S. Pat. No. 6,729,560 to Foster et al. describes a trigger sprayer fluidically coupled to two separate reservoirs containing separate liquids. In the sprayer discharge passage the two separate liquids are mixed together prior to their being dispensed as a spray. Dual component trigger sprayers are also described in U.S. Pat. No. 5,857,591 to Bachand, U.S. Pat. No. 6,550,694 to Foster et al. and U.S. Pat. No. 5,767,055 to Choy et al., the disclosures of which are fully incorporated herein by reference.

Spray dispensers of the art, comprising a sprayer pre-positioned onto a bottle or reservoir containing product, tend to be designed and configured for use with a single type of liquid product. Often, when the product contained in the reservoir is used up, the reservoir, together with the spray dispenser element, is simply discarded. Dispensers which can be transferred to a fresh bottle or reservoir containing new product are known, but the transfer of sprayer portion to the new reservoir can be messy, with product often dripping from the sprayer during the transfer. Moreover, due to the absence of standardized coupling elements (e.g. screw threads), and bottle finish dimensions, replacing the reservoir is generally limited to the same product as that originally supplied.

The dispensers of the type described above require a fluid communication pathway between the reservoir and the pump inlet. Such a pathway generally comprises a dip tube, having a first end affixed to a fluid pump inlet and a second, open, end immersed in the fluid within the reservoir. The dip tube tends to retain some of the product, and thus complicates the problem of interchangeability and interoperability of the sprayer with various product reservoirs, especially when the liquids are not compatible. The need for a dip tube further mitigates against many types of simple and secure means of attaching or coupling the sprayer to the reservoir or bottle, as the dip tubes of the art necessarily protrude from the sprayer, limiting the available ways of coupling the two.

Moreover, the use of a single sprayer sequentially with multiple reservoirs containing a range of different liquid products therein is not generally practiced due to the potential incompatibility of various ingredients contained in the range of products.

The aforementioned spray dispensers of the art, wherein the sprayer head is pre-positioned on the product reservoir, additionally require some means to seal the dispenser to prevent liquid from leaking from the sprayer nozzle orifice during shipment.

Providing a spray head independent from the product reservoir offers advantages during shipping. Integrating the dip tube with the product reservoir allows the dip tube to reach farther towards the bottom of the product reservoir, assuring complete use of product contained therein.

It is therefore an object of the present invention to provide an improved sprayer that can be quickly and easily attached or detached from the product reservoir container.

It is another object of present invention to provide a fluid dispenser that can be simply and easily transferred from one product reservoir to another, and which minimizes liquid leakage or drippage during such transfer.

It is another object of present invention to provide an interoperable fluid dispenser which optimizes use of structural material, and minimizes material which must be discarded.

It is yet another object of the present invention to provide an interoperable fluid dispenser which provides a user-noticeable signal to ensure the security of interconnection.

It is another object of the present invention to provide an interoperable fluid dispenser which can incorporate a manually-actuated, electrically-driven pump, or a manually-driven pump mechanism.

It is another object of the present invention to provide a sprayer and a product reservoir which incorporate a quick-connect coupling means for sealingly mating the two.

It is yet another object of the present invention to provide a sprayer for use with a reservoir having an integral dip tube, wherein the spray head mates therewith in fluid-tight fashion.

It is a still further object of the present invention to provide a sprayer and reservoir which can be used in an inverted, as well as upright, position.

It is yet another object of the present invention to provide a system, method and apparatus whereby selected information concerning the liquid product contained in the reservoir is communicated to the sprayer, and/or the user.

It is an additional object of the present invention to provide a sprayer capable of selectively dispensing a liquid phase, a vapor phase, or a combination.

### SUMMARY OF THE INVENTION

In accordance with the above objects and those that will be mentioned and will become apparent below, one aspect of the present invention comprises a liquid dispenser or sprayer which may be removably attached to a bottle or reservoir. The sprayer includes a discharge nozzle, a pump, an actuation mechanism for the pump, and optionally, a venting system. The pump includes a fluid inlet, pump chamber, piston and a fluid outlet fluidically coupled to a discharge nozzle. A vent piston may be connected to the pump piston and mounted in the vent chamber. Reciprocating movements of the vent piston between a closed venting position and an open venting position of the vent piston relative to the vent chamber allow air into the chamber. A trigger is typically mounted on the sprayer housing by a pivot connection at one end of the trigger. The trigger is connected to the pump piston and, optionally, the vent piston. Optionally, at least one one-way, or check, valve, is arranged in the sprayer housing to prevent reverse flow of the fluid. The pump may be manually activated, or electrically powered, as by an electric motor. If the latter, the electrically driven pump may be manually actuated, as by pulling a trigger, depressing a mechanical contact, or by actuating a switch. It is, however, within the scope of the present invention to provide a sprayer and/or dispenser and method of use thereof wherein the sprayer is automatically actuated in response to an external stimulus, or a predetermined time interval.

In preferred embodiments of the sprayer, there is provided a quick-release coupling system comprising a first coupling release means fitted or attached to the sprayer, and a second coupling means fitted or attached to the product reservoir, wherein the first and second coupling means are complementary, and together form the quick-release coupling system. In one embodiment, the quick-release coupling system comprises an interference or a compression type fitting. Examples include a bayonet-style mounting, a flat-faced, hose-style coupling, a snap and socket, and a pin and socket mounting. In another embodiment, the quick release means comprises a magnetic or electromagnetic fitting.

The bottle includes an opening about which the sprayer may be removably attached. About an upper circumference of the opening is a quick-release mounting means, which is complementary to that which is affixed to the sprayer. In one embodiment, the bottle includes an integral dip tube to provide a fluid path from the bottle to the pump inlet of the sprayer.

In a particularly preferred embodiment of the present invention, a communication means communicates between the reservoir and the sprayer to provide information relating to the liquid contents of the reservoir, that is acted on, either autonomously by the sprayer, or by the user, such that product safety, efficacy, convenience or combinations thereof is optimized. The information concerning the liquid may be conveyed to the user/consumer via the sprayer such that the user/consumer is part of the information/feedback loop (i.e. the user can decide how to use the information), or the information may be communicated to the sprayer, which directly acts on the information without input from the consumer. For example, the communication means may operate in conjunction with an electrically-powered nozzle and/or an electrically-powered pump system to autonomously configure the sprayer for the safest, most effective or most convenient spray pattern for the particular liquid contained in the reservoir. Volume indications of liquid remaining may also be provided.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a perspective view of a liquid dispensing device of the present invention, showing the general relationship of the sprayer to the bottle;

FIG. 2 is a cut-away view of the liquid dispensing device of the present invention, generally illustrating the internal components of a manually-actuated sprayer;

FIG. 3 is a schematic, cut-away side view of one embodiment of the liquid dispensing device of the present invention, showing an electrically-powered sprayer;

FIG. 4 is a perspective view of another embodiment of liquid dispensing device of the present invention, schematically showing a sprayer operated by water pressure;

FIG. 5 is a cut-away side view of the liquid dispensing device of the present invention, generally illustrating the internal components of an electrically-powered reconfigurable dispensing nozzle;

FIG. 6 is a cut-away side view of the dispenser of the present invention, showing one embodiment of a quick-release coupling system;

FIG. 7 is a perspective view of the liquid dispensing device of the present invention, showing another embodiment of the quick-release coupling system;

FIG. 8 is a perspective view of the liquid dispensing device of the present invention, showing yet another embodiment of the quick-release coupling system;

FIG. 9 is a perspective view of the liquid dispensing device of the present invention, showing still another embodiment of the quick-release coupling system;

FIG. 10 is a perspective view of the liquid dispensing device of the present invention, showing a further embodiment of the quick-release coupling system;

FIG. 11 is a perspective view of the liquid dispensing device of the present invention, showing another embodiment of the quick-release coupling system;

FIG. 12 is a perspective view of the liquid dispensing device of the present invention, showing another embodiment of the quick-release coupling system;

FIG. 13 is a perspective view of the liquid dispensing device of the present invention, showing an integral dip-tube and another embodiment of the quick-release coupling system;

FIGS. 14A-14B are perspective views of another embodiment of the dispenser of the present invention, showing a mechanical information communication means operable between sprayer and container;

FIGS. 15A-15B are schematic diagrams of one embodiment of an electronic communication means operable between sprayer and container, showing details of the sensors and logic circuit;

FIG. 16 is a schematic cut away view of an embodiment of a self-sealing dip-tube of the dispenser of the present invention;

FIG. 17 is a perspective view of an embodiment of the dispenser of the present invention showing a dip-tube operable in an inverted position; and

FIG. 18 is a perspective view of an embodiment of the dispenser of the present invention showing another embodiment of a dip-tube operable in an inverted position.

### DETAILED DESCRIPTION OF THE INVENTION

Before describing the present invention in detail, it is to be understood that the invention is not limited to the particularly exemplified structure, elements, systems or processes disclosed herein, which may vary. It is also to be understood that the terminology used herein is for the purpose of describing particular embodiments of the invention only, and is not intended to limit the scope of the invention in any manner.

### DEFINITIONS

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include the plural unless the content clearly dictates otherwise. Thus, for example, reference to a “surfactant” includes one, two, or more such surfactants.

Unless defined otherwise, all technical and scientific terms used herein have the same meaning as commonly understood by one of ordinary skill in the art to which the invention pertains.

Effective amounts are generally those amounts listed as the ranges or levels of ingredients in the descriptions, which follow hereto. Unless otherwise stated, amounts listed in percentage (“%'s”) are in weight percent (based on 100% active) of the liquid composition alone.

As used herein, “disposable” is used in its ordinary sense to mean an article that is discarded (or preferably, the components thereof are recycled) after a limited number of usage events, preferably less than 25, more preferably less than about 10, and most preferably less than about 2 usage events.

As used herein, unless otherwise clear from the context, “reservoir” and “bottle” are used interchangeable to define the structural element which contains the liquid to be dispensed. “Sprayer”, and “dispenser” are used interchangeably to define the assembly which contains the pumping elements, and which the user actuates to deliver liquid from the reservoir to the desired surface.

The terms “consumer” and “user” are similarly considered interchangeable (unless otherwise clear from the context), and both refer to the person or persons who utilize or operate the dispensers and sprayers of the present invention for their intended purposes.

It is to be understood that unless otherwise clear from the context, any feature, structure, element, sub-system, condition or parameter described in connection with a particular embodiment of the invention herein may be applicable, as known to one skilled in the art, to any other embodiment of the invention described herein. Similarly, use of the term “one embodiment” with reference to any feature, structure, element, sub-system, condition or parameter is not meant to limit to the disclosed embodiment.

The term “liquid” is meant to include any fluid whether in a viscous (thickened) state, or non-viscous, and any type of rheology, including shear-thinning, shear thickening, thixotropic, plastic, pseudoplastic and rheopectic. Fluid is further defined herein to include gases, including a vapor phase component of a liquid.

Hand-Held Trigger-Actuated Pump Sprayers

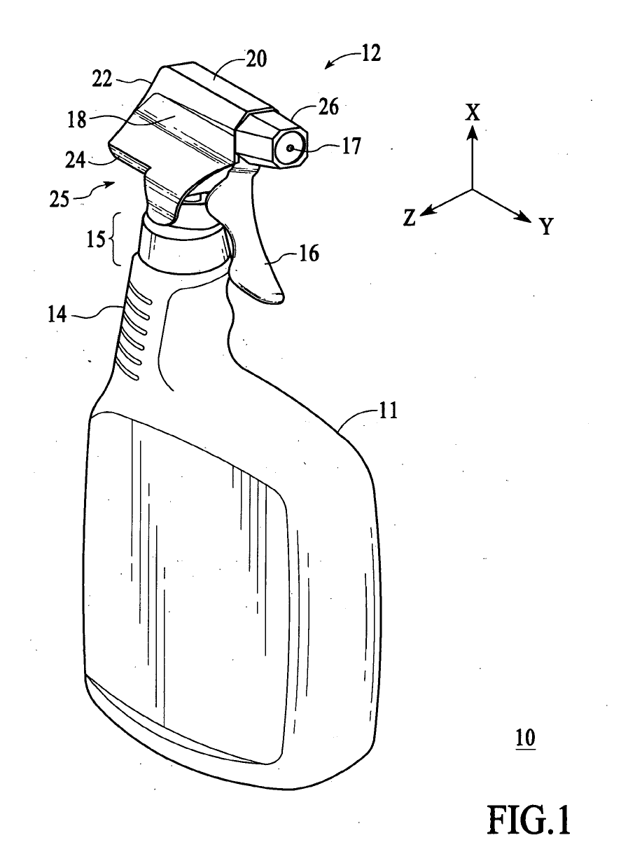

FIG. 1 is a perspective view of a liquid dispensing device of the present invention, generally referred to by the numeral 10. The “X” axis defines the long, or nominally vertical, axis of the container and spray head and runs through the center of the neck opening. The “Y” axis is orthogonal to the X axis, and defines the longest axis of the sprayer, forming the axis along which liquid is directed therefrom. A “Z” axis is any axis orthogonal to the “X” axis that is not the “Y” axis.

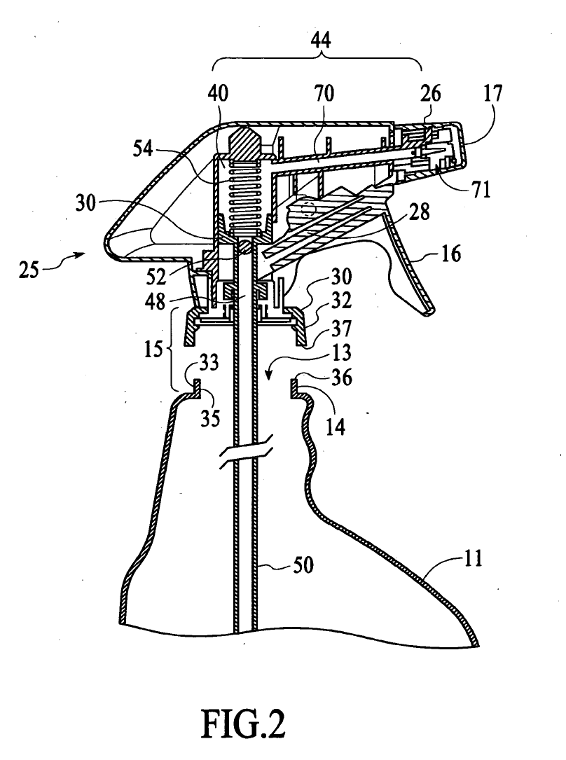

Referring to FIGS. 1 and 2, the dispenser 10 generally comprises a liquid-filled container or reservoir 11 and a pump body or sprayer 12, releasably connected to the container 11 about an upper fluid infill opening 13 of a neck 14, with a quick-release coupling system 15. The dispenser 10 is particularly suited for spraying a liquid cleaning agent such as a conventional all purpose cleaner. The liquid from the reservoir 11 is dispensed from a liquid discharge orifice 17. The trigger 16 enables an individual user to operate the dispenser 10. The exterior features of the sprayer 12 include: a pair of sidewalls 18, (the opposite, congruent sidewall not shown), a top wall 20 that blends into a rear wall 22, and a lower surface 24. The exterior covering of the sprayer 12 comprises generally, the side walls 18, top wall 20, rear wall 22 and lower surface 24, which collectively define a shroud 25. A nozzle cap 26 and the pivoted trigger 16 are disposed on the front end of the sprayer 12. The trigger 16 is operatively connected by an arm 28 to a piston 30 (shown in FIG. 2).

FIG. 2 further illustrates one embodiment of an internal mechanism of the sprayer 12 which when activated delivers a liquid product from the container 11 through the liquid discharge orifice 17 within the nozzle cap 26. FIG. 2 also shows schematically a generic upper sleeve 32 of the quick-release coupling system 15, which mates with a lower sleeve 33 formed onto, or secured to, the reservoir 11. The lower sleeve 33 defines an inner peripheral wall 35, and has an upper-land sealing surface 36. The upper sleeve 32 has a lower land sealing surface 37 and defines a peripheral wall 38 about the outer circumferential surface thereof. In some embodiments of the present invention, the upper land sealing surface 36 sealingly mates with the lower land sealing surface 37 of the sleeve 32. The sleeves 32 and 33 are depicted as generally circular in cross-section (thus forming a cylinder), however, a variety of possible cross sectional shapes are suitable, including oval, elliptical, square and rectangular. Non radially symmetrical shapes can be employed to ensure a particular orientation of reservoir 11 with respect to sprayer 12, as will be more fully described herein.

Within the shroud 25, a pump chamber 40 is disposed. A fluid supply and discharge system 44 comprises the piston 30 and a piston fluid inlet conduit 48 that provides fluid to the pump chamber 40 from the container 11. The piston fluid inlet conduit 48 is fluidically coupled to a dip tube 50 that is adapted to extend into the container to draw fluid into the pump chamber 40 via the piston fluid inlet conduit 48 and an inlet ball check valve 52. The slideable piston 30, which is reciprocally disposed inside the pump chamber 40, is actuated against the bias of a coil spring 54 by squeezing trigger 16 thereby reducing the enclosed volume within the pump chamber 40. The piston inlet conduit 48 may be selectively blocked in response to pressure within the pump chamber 40 by the inlet ball valve 52. The fluid supply and discharge system 44 acts generally by creating a pressure differential between the reservoir 11 and the nozzle 17, thus forcing fluid out.

Fluid in the pump chamber 40 may be discharged from the dispenser through an outlet conduit 70 and a nozzle fitting 71. The nozzle fitting may include an operative discharge check valve (not shown). The fitting 71 and check valve are enclosed in the nozzle cap 26 which, depending on its position, controls the form of discharge, e.g., stream or spray. The discharge path includes the liquid discharge orifice 17. The nozzle cap 26 may be rotatable to permit outlet orifice 17 to be aligned with, and thus in fluid communication with, the outlet conduit 70, permitting fluid to be discharged, or the outlet orifice may be non-aligned with the outlet conduit 70, preventing liquid form being discharged. The sprayer 12 of the present invention can employ a variety of nozzles with the choice depending on a number of considerations such as (1) the size and/or shape of the spray pattern and (2) level of foaming desired. For example, the nozzle may have outlet orifices 17 of different sizes, i.e., diameters, or orifices with different configurations. Typically, the consumer can select the appropriate operating parameter(s), e.g., spray pattern, by rotating the nozzle cap 26. Suitable nozzles are well known in the art and are described, for example, in U.S. Pat. Nos. 4,313,568 to Shay and 6,446,882 to Dukes et al. both of which are fully incorporated herein by reference.

A wide variety of internal pump mechanisms can be used with the sprayer apparatus and methods of use thereof of the present invention. Numerous references disclose trigger-actuated pump mechanisms for dispensing a fluid from a reservoir, particularly a consumer product such as a spray cleaner, sanitizer, disinfectant, or other liquid agent which provides beneficial and/or desirable results when deposited upon a surface. Examples include conventional manually actuated piston or bellows-type pumps that are described, for example, in U.S. Pat. Nos. 4,227,650 to McKinney, 4,538,745 to Dunning et al., 6,213,236 to Bloom, 6,234,361 to Bloom, 6,332,562 to Sweeton, and 6,364,175 to Bloom all of which are incorporated herein by reference.

In a preferred embodiment, the pump mechanism is a trigger-actuated, mechanically powered pump of the reciprocating piston type, as more fully disclosed in U.S. Pat. No. 4,538,745, to Dunning et al, the disclosure of which is fully incorporated herein by reference.

Another trigger-actuated, mechanically-powered pump mechanism, suitable for use with the present invention, is a pressurized dispenser, also known as a compression sprayer. Such sprayers are disclosed, for example, in U.S. Patent Application Number 2004/0035884 to de la Guardia, filed Aug. 22, 2003, titled: Pressurizing Device for Attachment to Fluid Containers, commonly owned by the same assignee as the invention herein, the disclosure of which is fully incorporated herein by reference. The device in the above-referenced application acts to urge fluid out of the reservoir by pressurizing the headspace above the fluid. This sprayer affords the user the option of a continuous (over a period of time) spray of fluid without the need to continuously manually drive the pump mechanism.

Other suitable forms of pressurized dispensers include dispensers with flexible, or deformable sidewalls, or portions thereof, which dispense by manually squeezing the sides thereof. Such dispensers are commonly used to dispense a variety of typically viscous fluids, often by inverting the container and squeezing.

A particularly preferred, ergonomic handle for a conventional trigger sprayer mechanism is disclosed in U.S. patent application Ser. No. 10/776,543 filed Feb. 10, 2004, titled: Trigger Sprayer with Ergonomic Trigger, assigned to the same assignee as the invention disclosed herein, the disclosure of which is fully incorporated herein by reference.

Electrically-Powered Sprayers

In one embodiment of the present invention, the fluid supply and discharge system 44 may comprise a non-manually powered pump mechanism, in particular an electromotive means to convert electrical energy into mechanical energy. Such sprayers typically incorporate a small electric motor to drive the pump, which may be any type known to the art capable of moving a fluid at the desired pressure. Such pumps include, without limitation, centrifugal, helical, impeller, peristaltic, reciprocating piston and diaphragm. Suitable electrically-operated pumps are disclosed, for example in U.S. Pat. Nos. 5,716,007 to Nottingham et al. and 6,502,766 to Streuker et al., the disclosures of which are fully incorporated herein by reference. In general, such electrically-driven pumps incorporate a motor to supply rotary motion to a suitable gear train, which is mechanically coupled to a reciprocating, impeller or centrifugal type of pump.

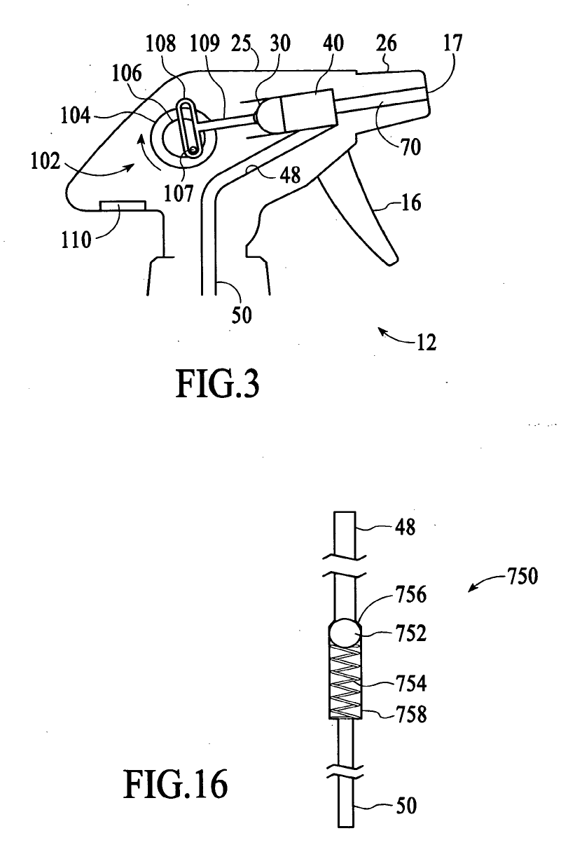

FIG. 3 schematically illustrates one embodiment of the present invention wherein the sprayer 12 incorporates an electrically-powered pump system 102. An output shaft (not shown) of a motor 104 is coupled to a cam member 106 having a crank 107. The crank 107 engages a race 108 at one end of a shaft 109. Shaft 109 has an opposite end which is connected to the piston 30 within the pump chamber 40. The cam member 106, crank 107, race 108 and shaft 109 convert rotary motion of the motor 104 to reciprocating motion to drive the piston 30, compressing and expanding the volume of chamber 40 and forcing liquid out the discharge orifice 17.

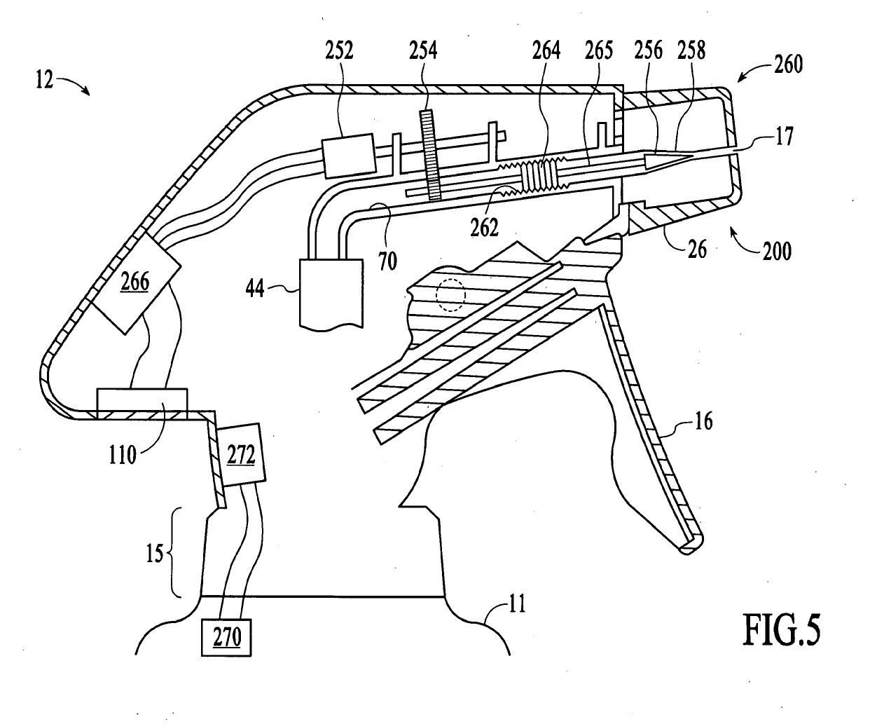

An electrical power source 110 for the pump motor 104 comprises an electrochemical cell or cells, such as a battery, or a self-powered source such as a photovoltaic device. The source of electrical power 110 may be located on the sprayer 12, the reservoir 11, or both. The trigger 16 may be modified to delete the mechanical linkage to the piston 30, and instead close an electrical contact (not shown) and complete a power-supply circuit (not shown) to actuate the motor 104. Additionally, the trigger 16 may be replaced with a conventional electrical switch (not shown) such as a pushbutton, toggle or slide switch. Optionally, a logic circuit (for example, that shown in FIG. 5) may be interposed between the switch and electrical source, and can be configured to operate the motor 104 and provide liquid discharge in a variety of predefined patterns. For example, the logic circuit can be set to provide a pulsed stream of liquid, or to provide a pre-selected spray duration with a single trigger pull (which can include dispensing all or part of the reservoir's contents), or to provide a minimum time interval between sprays, allowing both intermittent and/or continuous spray. In a preferred embodiment of the present invention, the power source is located on the reusable sprayer 12.

In other respects, such as the inclusion of optional elements such as a venting mechanism, (which may comprise a vent piston, a vent housing and a biasing means), check valves, discharge nozzle, etc., the electrical-pump sprayer 12 is substantially similar to the manual-pump sprayer 12, and is preferably equipped with the quick-release coupling system 15 as described herein.

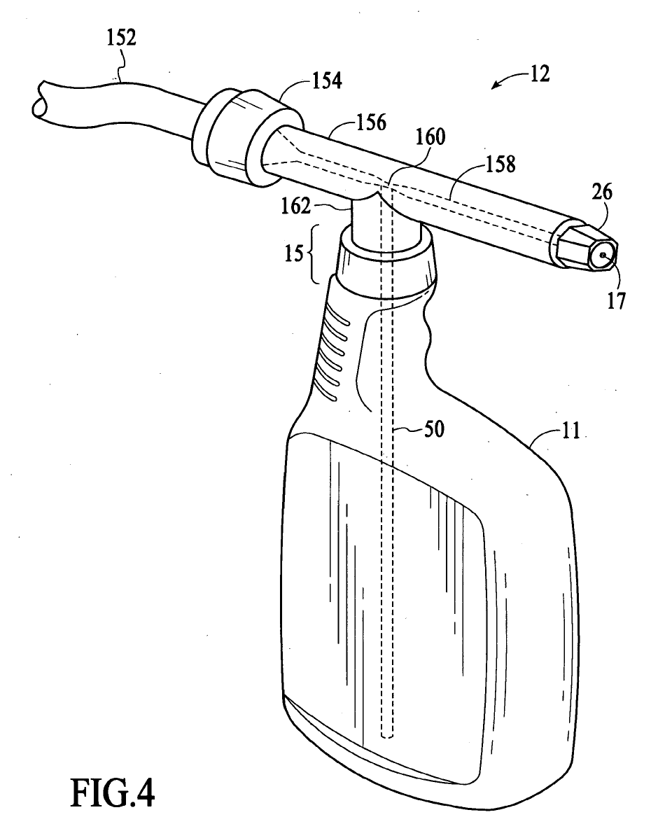

In another embodiment of the present invention, the differential pressure supplying the pumping force for drawing up liquid from the reservoir is obtained by passing a volume of fluid over a orifice to create a lower pressure within. Thus Bernoulli's Principle provides the pressure differential to draw up liquid and expel it through the discharge nozzle, thus forming a fluidically-powered fluid supply and discharge mechanism 44. In one embodiment of the present invention, a sprayer may be attached to a source of water under pressure, as a conventional garden hose. Referring to FIG. 4, another embodiment of the sprayer 12 of the present invention is shown. In this embodiment, a fluid, e.g. water, from a source under pressure is supplied by a hose 152 via a first sprayer coupling 154. The coupling 154 is preferably the quick-release system as described herein, but may also comprise a conventional threaded coupling. In fluid communication with the coupling 154 is a barrel 156 having an internal fluid channel 158, which is terminated by the nozzle cap 26 having the fluid discharge orifice 17. The fluid channel 158 preferably has a least one narrowed section 160 thereof having an interior diameter smaller than that of the fluid channel 158. A tee segment 162 is connected to the barrel 156 and contains the dip tube 50, which fluidically communicates with the narrowed section 160 of the fluid channel 158. The tee 162 is coupled to the reservoir 11 via the quick release coupling system 15, as described herein. The sprayer 12 utilizes the incoming velocity of the source fluid (typically water from a spigot) flowing across the narrowed section 160 of the fluid channel 158 to siphon liquid from the reservoir 11, expelling it through the fluid discharge nozzle 159. Additionally, the source fluid serves to dilute the active ingredients contained within the reservoir 11. The sprayer 12 may be provided with suitable valve means (not shown) to enable the user to selectively start and stop the flow of liquid, and/or to control the volume of discharged liquid.

In any sprayer or dispenser embodiment described or contemplated herein, the reservoir may comprise a single chamber and corresponding fluid, or may comprise multiple chambers containing multiple fluids.

Fluid Discharge Nozzle

The discharge nozzle may be fixed, providing a predefined spray pattern, such as a spray or stream, cone or fan, or may be adjustable to permit the user to select the spray pattern and/or volume and/or throw distance. In a preferred embodiment, the discharge nozzle is adjustable. With such a nozzle, flow and liquid volume may be controlled. With such an adjustable nozzle assembly, turning the nozzle in one direction creates a lower volume liquid mist and turning nozzle in the opposite direction creates a liquid stream with more volume.

The nozzle in this and other embodiments may form a fan spray, i.e., a nominally dove-tail shaped spray stream having a generally oval to rectangular spray pattern, as opposed to the typical round spray pattern formed by a conical spray stream. The fan spray is particularly useful for producing even spray coverage over large areas, and is especially effective when the fluid is discharged under pressure.

In some embodiments of the present invention the sprayer 12 has selectable discharge conditions. The cap 26 is rotatable between an off position where discharge from the nozzle assembly is prevented, a spray position where the discharge of liquid from the nozzle orifice is in a spray pattern and a stream position where the discharge of liquid is in a stream pattern. Optionally, the nozzle may include structure where the discharge of liquid is converted to a foam. Such a nozzle structure is described in U.S. Pat. No. 4,646,973 to Focaracci, the disclosure of which is incorporated by reference herein.

In one embodiment of the present invention wherein a source of electrical power is incorporated, either supplied from the sprayer 12 or from the reservoir 11, the sprayer 12 comprises a nozzle assembly 200 which is provided with an electrically-driven adjustment means to allow selection of the spray pattern and/or liquid volume and/or throw distance. This is a particularly preferred embodiment where the reservoir incorporates the power source, and also incorporates a product sensor. Referring to FIG. 5, there is shown schematically the sprayer 12, which incorporates a suitably-sized and dimensioned reversible motor 252, driving a gear train 254, in mechanical communication with a needle valve 256. At a discharge end (proximal to the discharge orifice 17) of the discharge outlet 70 there is a throat 258, within which the needle valve 256 is movably positioned. The valve 256 and throat 258 form the adjustable discharge nozzle 260. The throat 258 is supplied with a plurality of screw threads 262 formed within the outlet conduit 70, and mate with a plurality of threads 264 on a shaft 265 rotatably disposed coaxially within the outlet conduit 70. The shaft 265 is terminated at one end by the needle valve 256. When power is supplied to the motor 252 via an appropriate control means 266 (shown schematically) the needle valve 256 is driven to alter the geometry of the discharge nozzle 260, and thus vary the resulting spray pattern. In some embodiments, the sprayer 12 may be provided with a product sensor or plurality of product sensors 270 and a logic circuit 272 to send an appropriate signal to the nozzle drive motor 252, to define a particular spray pattern which optimizes distribution and/or efficacy of the particular product being dispensed. The product sensor 270 may be implemented as an analog or digital sensor, or combination thereof. If analog, for example, the sensor may measure a quality of liquid within the reservoir 11 such as pH, conductivity, salinity etc. As digital, the sensor may be a simple fluid level indicator to signify reaching a predefined use-up level. Multiple sensors 270 may be provided. Information form the sensor(s) 270 may be used as described herein. The sprayer 12 may also be also fitted with the quick-release coupling system 15. Note that for simplicity, other details of the sprayer 12, such as the pump mechanism, and structural elements, are not shown.

The adjustable discharge nozzle 260 affords advantages in addition to the ability to automatically or manually adjust spray pattern, spray volume and throw distance. Spray conditions, i.e. pattern, volume and throw, can also be optimized to the viscosity of the liquid or liquids contained in the reservoir 11. When supplied with the product sensor 270, as described above, and in more detail below, the automatic discharge nozzle 260 may be automatically configured. This is highly advantageous in dispensing liquids subject to changes in viscosity over time, or due to external influences such as temperature or sunlight. When the automatic discharge nozzle 260 of the sprayer 12 is combined with the quick-release coupling system 15, the maximum benefit is realized as the nozzle assembly 200 can be readily reconfigured to optimize dispensing of different liquids in sequence.

Coupling Means

In the preferred embodiments of the present invention, the sprayer 12 is removably secured to the reservoir 11 by means of a quick-release coupling system 15 to ensure a leak-tight seal between sprayer 12 and reservoir 11, and to provide for ease and simplicity of reservoir replacement. In such embodiments, the coupling means is a quick release coupling system of the type which permits swift and certain connection and disconnection between the elements, and with a minimum of steps or motions required by the user.

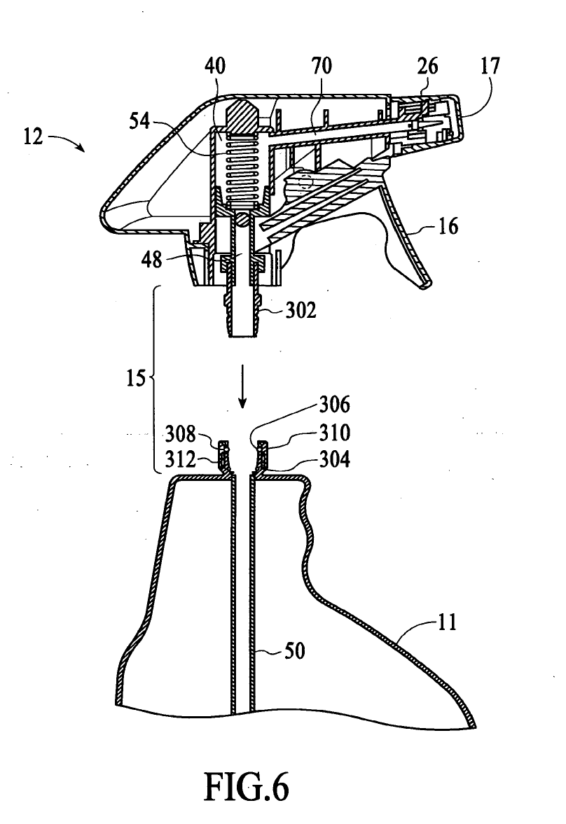

In one embodiment of the present invention, the quick-release coupling system 15 comprises a flat-faced quick-release (also known as a hose couple) coupling, comprising a male portion 302 and a female portion 304, as shown in FIG. 6. A ring of balls 306 is present in seats 308 formed in the outer body close to the end that couples onto the male portion. A sliding collar 310, subject to biasing action by a spring 312, is provided around the outside of the body and encloses the ring of balls. The collar 310 locks or releases the ring of balls 306 as the coupling is engaged.

The flat-faced quick release coupling system acts to prevent the ingress of air or the leakage of fluid during connection and disconnection, and permits attachment of the spray head to the container along the X axis. Use of the X axis as the axis of attachment permits the use of a conventional dip tube attached to the sprayer, or a dip tube which is integral with the reservoir. The X axis mode of attachment affords ergonomic advantages in that the user does not need to impart rotational force, or torque, to the sprayer to effect the attachment.

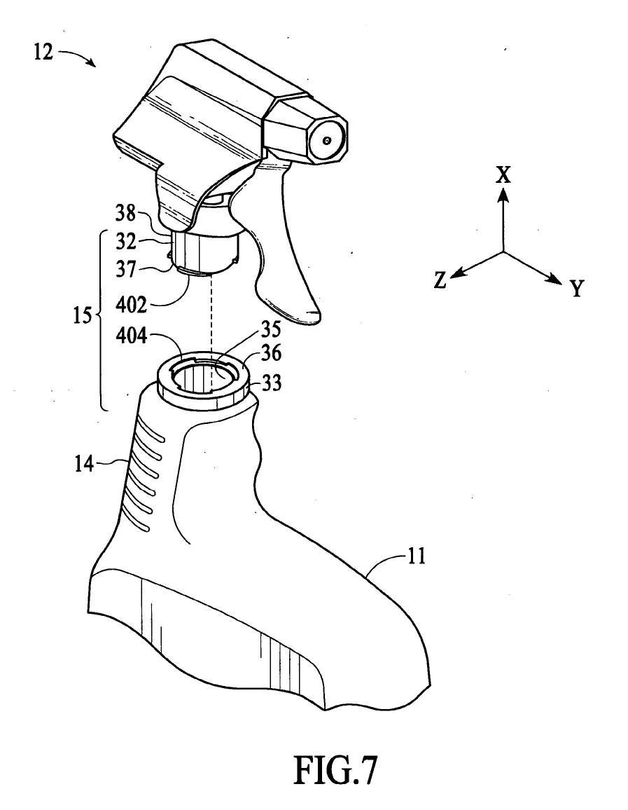

Referring to FIG. 7, another embodiment of the sprayer 12 of the present invention comprises a bayonet type mounting as the quick-release coupling system 15. Such a mounting includes at least one, and preferably at least two helical inclined planar ridge surface(s) 402 affixed to, or formed on, the outer peripheral wall 38 of the sleeve 32. A numerically and dimensionally complementary helical inclined planar groove or channel 404 is formed within the inner peripheral wall 35 of the reservoir 11. The helical inclined planar surfaces 402 and channels 404 generally extend about 60 to 120 degrees, preferably about 30 to 90 degrees about the circumference of the walls 35 and 38. The two components are secured by applying a torque, as by rotating, about the X axis. The torque is converted by the helical inclined planar surfaces to a compression along the X axis.

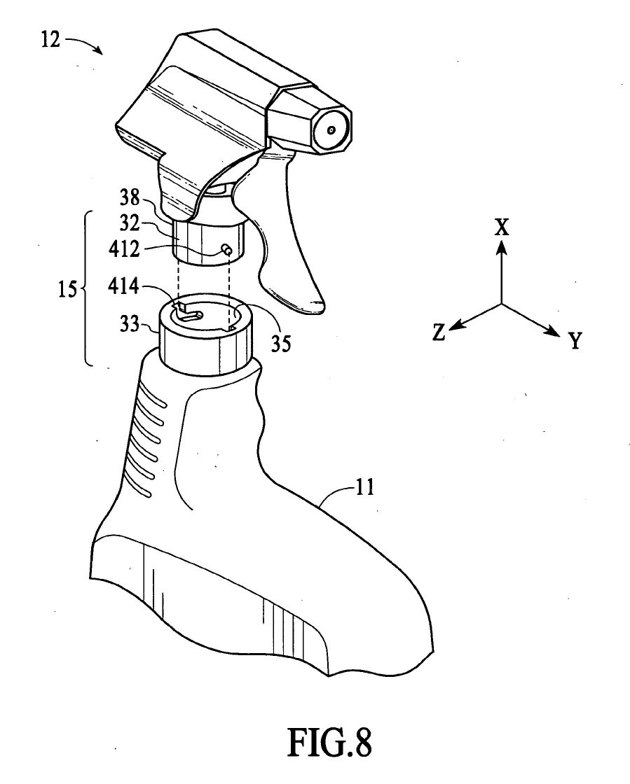

In another embodiment of the present invention, the quick-release coupling system 15 comprises a pin and track type fitting, illustrated in FIG. 8. This type of fitting is similar to a bayonet fitting, in that the complementary engaging elements act analogously to the inclined planar surfaces to supply a compression along the X axis. Thus at least one pin 412, and preferably at least two pins 412 protrude from the peripheral wall 38 of the sleeve 32, and each pin engages a complementary track 414 formed into the inner peripheral wall 35 of the sleeve 33. The track 414 is helical about, and inclined along, the X axis, such that mutual rotation of the sprayer 12 and reservoir 11 convert the rotational torque to compression about the X axis.

FIG. 9 illustrates yet another embodiment of the present invention wherein the quick-release coupling system 15 comprises a socket-and-snap design. In this embodiment, the sealing elements comprise at least one; and preferably a pair of snaps 424 which are biased outwardly to an open position, and corresponding detents or sockets 426. The snaps are formed onto, or affixed to an outer surface of the wall 38 of the sleeve 32. Preferably, the wall 38 includes a pair of opposing, generally planar surfaces 422 for the snaps 424. The sockets are cut into the inner wall 35 of the sleeve 33, and are positioned and dimensioned to receive the snaps 424. Preferably, the wall 35 includes a pair of opposing, generally planar surfaces 425 for the sockets 426. The snaps 424 may be biased by a separate a biasing means (not shown), such as a spring means, or by making the snaps 424 out of a memory-retaining resilient material. The sleeve 32 is dimensioned to fit snugly within the sleeve 33 of the reservoir 11. FIG. 9 depicts the sleeves 32 and 33 as being substantially rectangular in cross section, however, this is for purposes of illustration only as a variety of shapes are suitable, including circular and oval, all as known to one skilled in the art. When the sleeve 32 of the sprayer 12 is inserted onto the sleeve 33 of the reservoir 11, the biasing force on the snaps 424 creates a resistance until the snap 424 meets with the socket 426 formed or cut into the wall 35. At this point, the biasing force combined with the design of the sockets 426 produce a consistent locking force, resulting in a secure connection between the two components. To release the sprayer 12, each socket 426 is provided with a button or tab 428, in mechanical communication with the snap 424. Manually pushing or depressing the button or tab 428 overcomes the outward biasing force upon snaps 424, causing them to retract flat against the collar 422 and freeing the sprayer 12 to be lifted upwardly.

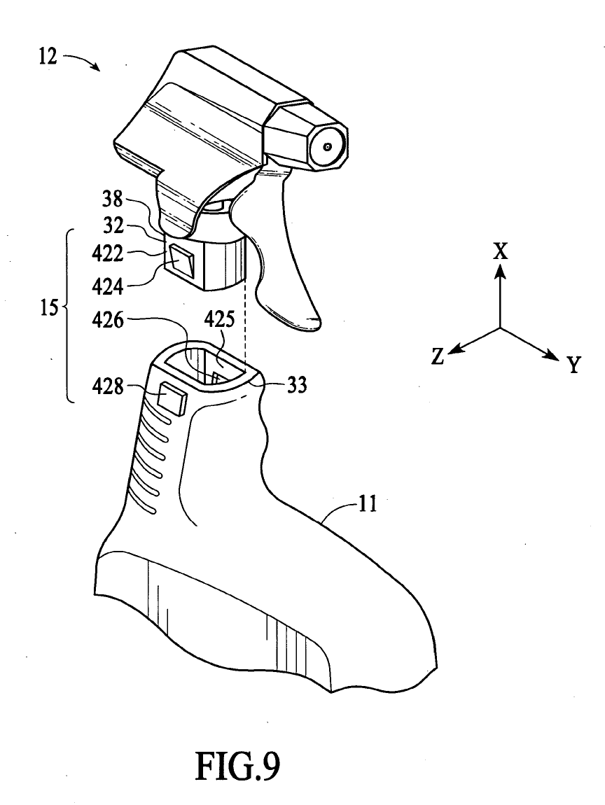

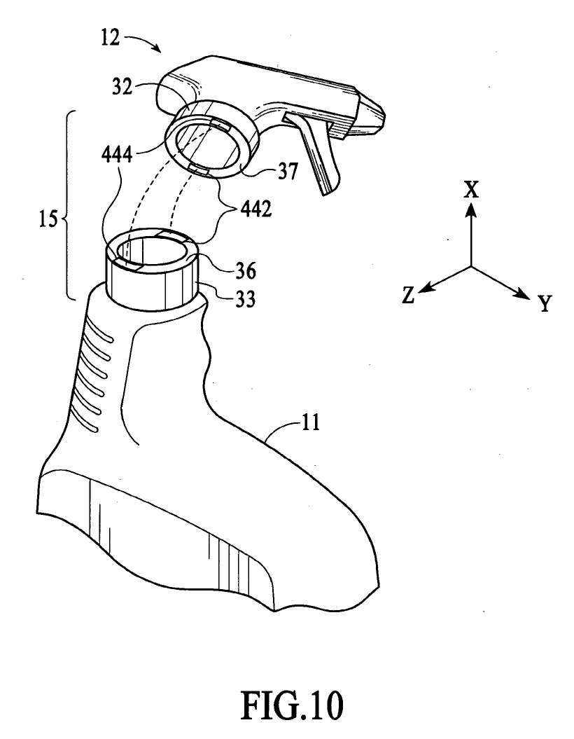

In still another embodiment of the present invention, illustrated schematically in FIG. 10, there is provided the quick-release coupling system 15 which comprises magnetic elements which engage by mutual magnetic attraction. In this embodiment, the quick-release coupling system 15 comprises at least one pair, and preferably two pairs of complementary magnets 442 and 444, disposed about the upper and lower sealing surfaces 36 and 37 of the sleeves 33 and 32. The magnets 442 and/or 444 can include a single continuous magnet on each of the surfaces 36 and 37, or can comprise a series of discrete magnetic elements, as depicted in FIG. 10. The magnetic element or elements are preferably mounted on both the surfaces 36 and 37, although a complementary ferrous metal plate (not shown) or plates can take the place of one of the pairs of magnets. The magnetic element or elements are configured and dimensioned to align and secure the sprayer 12 to the reservoir 11. In a preferred embodiment of the present invention, magnetic elements of opposite polarities are placed about both the sprayer and the reservoir, and act cooperatively to firmly secure the two components, and to provide a particular orientation, for example, to align the sprayer 12 about the sprayer's Y axis. In some embodiments as described herein, a source of electrical power is available on either or both the sprayer 12 and/or the reservoir 11. Such source of electrical power can be used to power an electromagnet, providing a simple and positive way of repeatably coupling and decoupling the sprayer 12 and reservoir 11. The use of a magnetic coupling means, especially an electromagnetic coupling means, further provides a consumer-noticeable indication of a positive seal, both through auditory and tactile feedback. Additionally, the magnet elements 442 and/or 444 may be employed to complete a signaling circuit (not shown) to provide a user-detectable visual or audible signal, such as illumination of a lamp, or a tone, to signify integrity of the coupling.

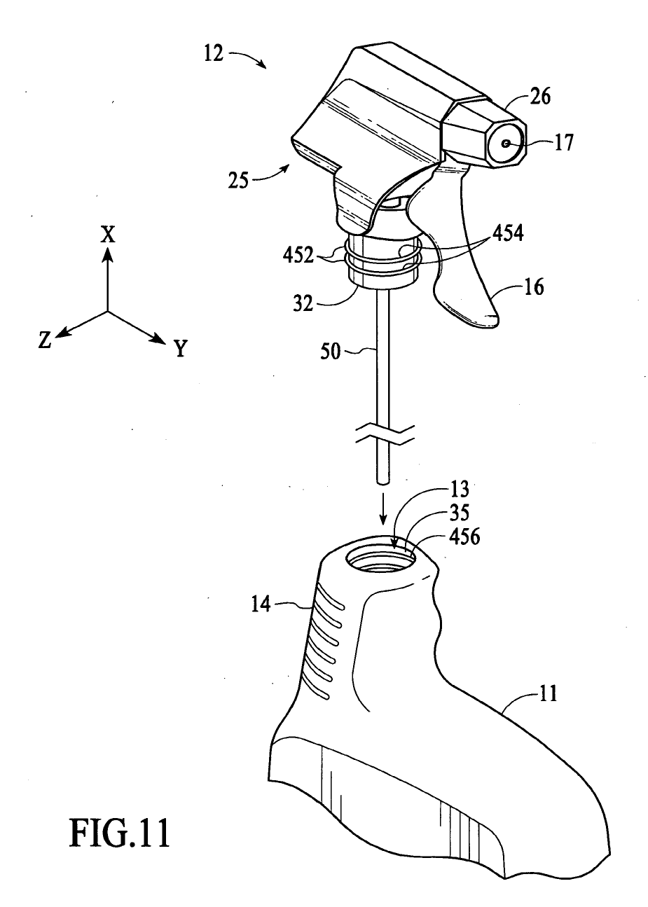

In still another embodiment of the present invention, there is provided a quick-release coupling system 15, comprising an interference fitting. In this embodiment, depicted in FIG. 11, the sprayer 12 includes an elongated (relative to the X axis) sleeve 32 having an outside diameter of the peripheral wall 38 only slightly smaller than the inner peripheral wall 35 of the sleeve 33. At least one, preferably two or more annular sealing rings or gaskets 452 are provided about the outer circumference of the sleeve 32, and preferably reside in peripheral channels 454. A dimensionally complementary annular channel 456 may be provided on the inner surface of the peripheral wall 35, for receiving the gasket(s) 422. The gaskets 452 thus aid in providing a leak-tight interference fit within the inner circumferential wall 35 of the sleeve 33.

It can be readily appreciated by one skilled in the art that some of the forgoing embodiments of the coupling means are preferably configured to permit engagement/dis-engagement about the X axis, while others may be configured to permit engagement/dis-engagement about the X, Y or Z axes. Thus the bayonet, pin and track, snap and groove and interference types of quick-release coupling systems 15 are nominally configured such that the two components are aligned by bringing them together along the X axis. The magnetic coupling system may be engaged by bringing the corresponding elements together about the X axis, but may also be engaged about the Y or Z axes.

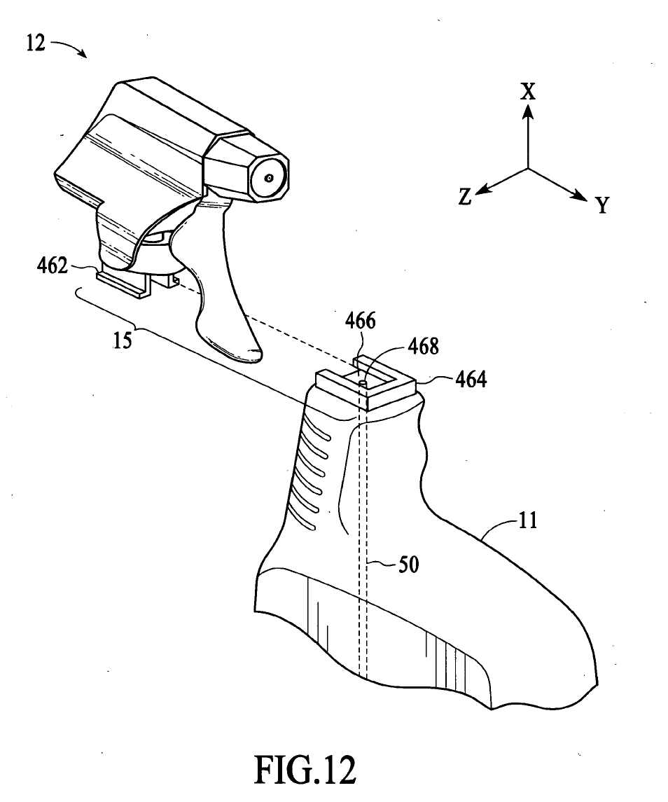

FIG. 12 illustrates such another embodiment of the quick-release coupling system 15 of the present invention wherein the engagement means is designed to be engaged about the Y axis. Thus a key-coupler means is shown schematically, wherein there is key component 462 mounted about the lower land surface 37 of the sleeve 32 of the sprayer 12. There is a corresponding keeper component 464 mounted about the upper land surface 36 of the neck 14 of the reservoir 11. The key 462 comprises a pair of L-shaped guides, mounted on opposite sides of the sleeve 32. The keeper component 464 comprises a pair of complementary, inverted inter-engaging L-shaped guides, mounted atop the surface 36 of the sleeve 33 of neck 14. Both or either of the keeper 464 and key 462 may be formed as a unitary piece, for example an open rectangle or a U-shape, or may be laterally separate components. If laterally separate, a stop means for stopping the key component 462 relative to the keeper component 464 should be provided. In use, the two components are simply slid laterally with respect to one another until locked. In such embodiment, it will be appreciated that the dip tube 50 is preferably secured within the reservoir 11. In this embodiment, it is preferred that the fluid infill opening 13 of the reservoir 11 is sealed, as manufactured, by a plug 466. The plug 466 is provided with a punctureable fluid seal 468, and the sprayer 12 is provided with a probe means (not shown) to puncture the seal 468 in use. This assures a leak-proof seal between the dip tube 50 and the piston fluid inlet conduit 48 of the sprayer 12. It can be appreciated that in this embodiment, there need be no fluid-tight seal between the upper and lower sealing surfaces 36 and 37, as fluid tightness is afforded by the plug 466, seal 468 and probe element. Optionally, the key and keeper components 462 and 464 may be provided with detents (not shown) to signify to the user proper engagement. In a preferred embodiment, the detents are dimensioned and configured to yield an audible click and/or tactile feedback when properly engaged. The key coupler means may also be dimensioned and configured to implement an automatic puncturing of the seal 468. In this embodiment, the key 462 and keeper 464 are formed as inclined ramps, so that lateral movement along the Y axis is converted, in part to compression along the X axis. The sprayer 12 is provided with an appropriate probe (not shown) to align with and puncture the seal 468 upon engagement, thus assuring leak-tightness of the components, and preventing spillage during shipping and storage.

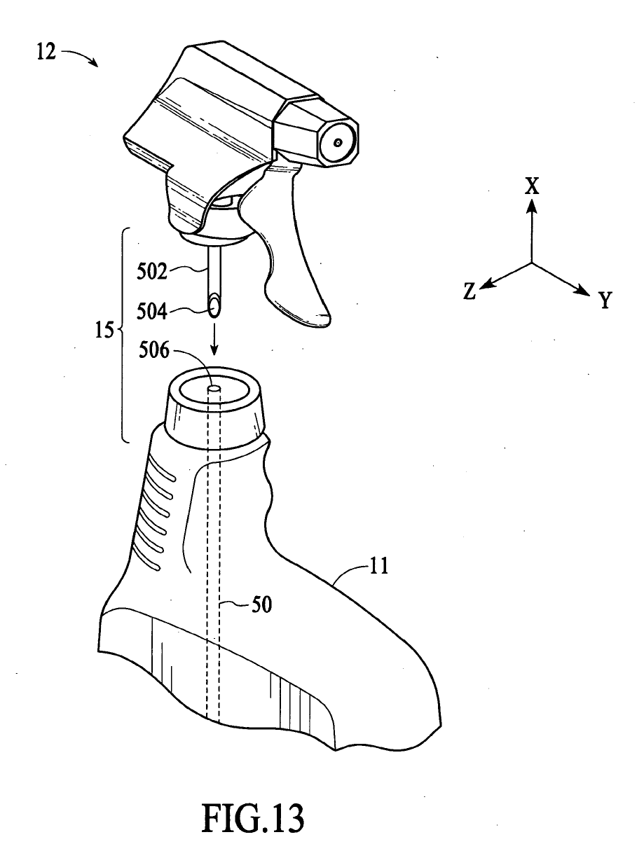

In embodiments of the present invention where the sprayer 12 and reservoir 11 engage about the X or Y axes, it can be appreciated that the dip tube 50 is preferably integral to the bottle, as further described herein. FIG. 13 illustrates such an arrangement wherein reservoir 11 includes the dip tube 50 coaxially located with the fluid infill opening 13 of the neck 14. When the sprayer 12 is aligned and secured to the reservoir 11 in any of the embodiments described herein, the dip tube 50 will be aligned and in fluid communication with the piston fluid inlet conduit 48. Suitable gasket or sealing means (not shown) may be provided to improve fluid integrity. While the integral dip tube 50 is preferably used in conjunction with the quick-release coupling system 15 which secures about the Y or Z axes as described, the integral dip tube may also be advantageously used with any means of coupling the sprayer 12 and reservoir 11. FIG. 13 also depicts an embodiment of the present invention wherein the sprayer 12 includes a probe 502 having a piercing element 504 at a distal end thereof. The reservoir 11 with integral dip tube 50 then may include a punctureable, liquid-tight seal 506 over an upper end of the dip tube 50. This seal 506 allows storage and shipping of the reservoir 11, and helps to prevent inadvertent spillage. When the sprayer 12 is coupled to the reservoir 11, the probe 502 will pierce the seal 506 and provide the requisite fluid pathway.

Any of the forgoing embodiments of the quick-release coupling system 15 of the present invention which rely upon mechanical inter-engaging elements may be provided with a gasket or gaskets, or a ferrule and ferrule seat, about the sealing surfaces to further improve the integrity of the fluid-tight seal. The quick-release coupling system 15 may include a ferrule and ferrule seat to improve the leak-tightness between components of the coupling system.

In embodiments of dispensers of the present invention having the quick-release coupling system 15, the sprayer 12 and reservoir 11 components are preferably engaged or disengaged by a consumer in less than about 5 seconds, more preferably in less than about 4 seconds, still more preferably in less than about 3 seconds, and most preferably in less than about 2 seconds. It is preferred that engagement or disengagement be achieved with only two steps or motions, and more preferably with only one step of motion on the part of the user. Still further, it is preferable that the engagement/disengagement occur along or about no more than two axes, preferably about only one axis, and most preferably linearly about one axis. Where the engagement/disengagement occurs about two axes, it is preferred that it comprises a linear motion about the X axis, and a rotational motion which is less than 360 degrees, centered about the X axis. Where engagement or disengagement comprises rotational motion, it is preferred that the amount of rotation needed is less than about 90 degrees, preferably less than about 60 degrees and more preferably less than about 30 degrees.

In at least one embodiment of the present invention, it is preferred that the quick-release coupling system 15 supply a consumer or user perceptible signal that the sprayer 12 is secured to the reservoir 11. Desirable signals may comprise visible, audible and/or tactile signals, which are seen, heard and/or felt. Examples include a click or snap as mechanical elements engage. An audible signal may be produced by including a tab and detent, or pair of tabs and corresponding detents, on the opposing interlocking elements. The interlocking mechanical elements can also provide tactile feedback to the user. The user-perceptible signal may be an electronically generated visual or audible signal, for example an indicator light or light array, other electronic displays or an audible tone. Colored structural elements can be employed, such that when the two portions of the coupling means are locked, primary colored elements align to create a secondary color. Correct alignment and locking may be signaled by the display of indicator flags, mechanically linked to the structure of the coupling means. In some embodiments, the sprayer 12 can be configured such that fluid can not be dispensed unless the sprayer 12 and reservoir 11 are secured in a leak-tight manner. In some embodiments, the reservoir infill opening 13, and corresponding sprayer sealing surface of the sleeve 32 may be dimensioned such that the two can be secured in only one orientation, thus assuring the seal. For example, the sealing surfaces may be non-circular, such as oval, ellipsoidal or rectangular, thus forcing the correct alignment in one of two ways. Certain geometries, such as oval or rectangular, may permit more than one discrete sealing orientation, e.g. two orientations if the sealing surfaces are oval or rectangular. This could permit a first and a second orientation, wherein dispensing or spraying or both conditions differ between orientations. For example, a first orientation may engage a first dip tube 50, and a second orientation engage a second dip tube 50 which differs in some respect, e.g. length or diameter, to alter a characteristic of the resultant spray output.

In one embodiment of the present invention, it is preferred that the reservoir 11 and sprayer 12 include a communication means or communication system 600 to supply information about the contents of the reservoir 11 either to the consumer/user, or directly to the sprayer 12. The communication means 600 may communicate mechanically, as by a series of signaling protrusions, pins, apertures etc mounted about the sleeve 33 on the reservoir 11, and corresponding complementary receiving structure mounted about the sprayer sleeve 32. By use of a code, information can be encoded in the signaling structures on the reservoir 11, and the encoded information is read by the corresponding receiving structure(s) on the sprayer 12. As with the embodiments disclosed above, the information is encoded with a suitable protocol appropriate for the mode of communication, and in one embodiment, comprises a binary code. The result may comprise a user-detectable display on the sprayer 12, such that the user/consumer is part of the information/feedback loop, or may directly engage a linkage on the sprayer to autonomously configure a feature or features on the sprayer 12. For example the communication means 600 may provide a binary code which can be input to the logic circuit 272 of the nozzle assemble 200 to configure the automatic nozzle 260 to provide the safest, most effective or most convenient spray pattern for the particular liquid contained in the reservoir 11.

The communication means 600 may comprise a user-detectable flag or flags, which are covered or revealed as appropriate to convey the information to the user. Alternatively, an autonomously-configured linkage may be provided, such as a mechanical link to the sprayer nozzle to set it to a particular configuration, or an automatic shut-off for the fluid supply and discharge system 44. Examples of information content that may be provided between reservoir 11 and sprayer 12 include the expiration or near expiration of product efficacy, fill status of the reservoir 11, including nearly empty and empty. Non radially-symmetrical opening/mating geometries may be useful to assure proper alignment of elements of the communication means 600. If implemented to include an electrical component, the communication means 600 preferably includes self test logic to assure correct alignment and integrity, and a means of relaying such information to the consumer, as by a visual or audible signal.

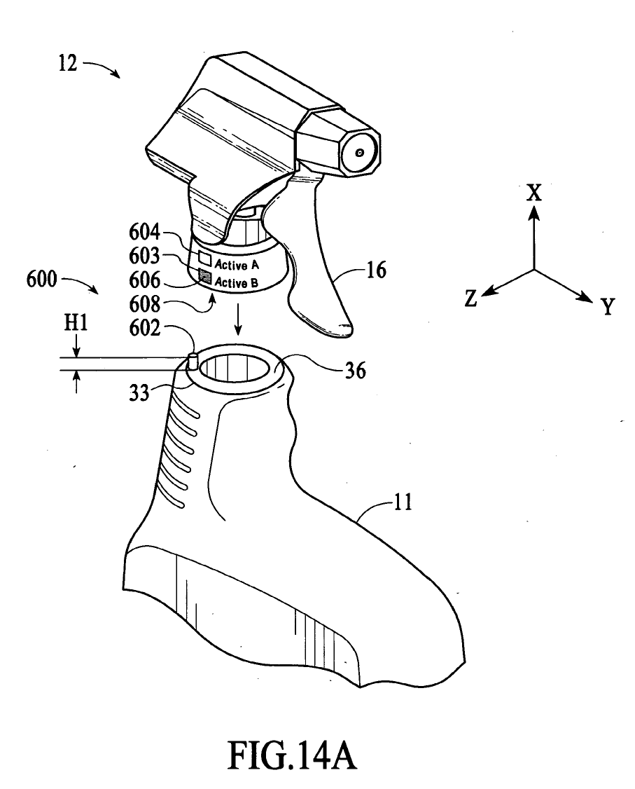

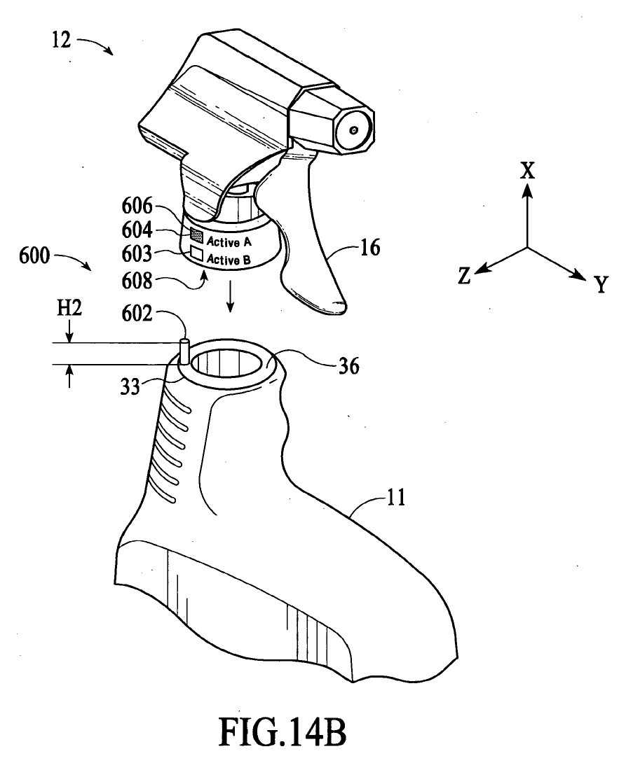

FIGS. 14A and 14B depict an embodiment of the present invention wherein mechanical elements are employed as the communication means 600 to communicate product attributes from reservoir 11 to sprayer 12. Referring to FIG. 14A, there is shown a pin 602, having a length “H1” positioned upon the surface 36 of the sleeve 33. The sprayer 12 includes, on sleeve 32, a lower window 603 and upper window 604 which signify to the user a particular condition, parameter or compatibility issue with regard to the contents of the reservoir 11. When the sprayer 12 is affixed to the reservoir 11, the pin 602 contacts a flag 606 slidably positioned within an aperture 608 inside the sleeve 32, and urges the flag 606 upwardly to be visible within window 603 or 604. By varying the pin height, the flag 606 is positioned to be visible in the upper window 604 or lower window 603. As seen in FIG. 14B, the pin 602 has a height “H2” thus urging the flag 606 to be visible within upper window 604. In the FIGS, the lower window 603 signifies, for example, an ammonia-containing formulation, while the upper window 604 signifies a bleach-containing formulation. In is to be noted that the number and arrangement of windows, and flags, and the type and structure mechanical linkages between the reservoir 11 and sprayer 12 may be modified as known by one skilled in the art. This arrangement also aids in correctly aligning the sprayer 12 with respect to the reservoir 11, through the alignment of pin 602 with aperture 608.

The communication means 600 may communicate product attributes between reservoir 11 and sprayer 12 by electronic means. FIG. 15A depicts a generalized circuit schematic of one such embodiment of the present invention. Referring to the FIG, there is a sensor means 632 (which may comprise a single sensor, or more than one sensor, or an array of sensors), a logic circuit or processor means 634, a power source 636 and output means 638. The output means 638 may be in the form of a user-perceptible signal, such as at least one LED, LCD or lamp or display (shown in FIG. 15B) or audible tone generator, or the output means may directly control a sprayer delivery mode. In the latter situation, the output means 638 can drive an element of the fluid supply and discharge mechanism 44, such as the pump motor 104 to provide a specific delivery protocol, or can drive a feature of the nozzle 200, such as the adjustable nozzle 260 (shown in FIG. 5). The result can be used to provide a specific spray pattern, delivery volume, throw distance, spray timing or other protocol, or any combination thereof, tailored to the contents of the reservoir 11. The processor means 634 may also retain in memory information from a prior usage and/or contents of a prior reservoir 11, and either signal the user, adjust delivery conditions or both, based in part upon compatibility parameters of fluid in the reservoir 11 compared with those of the contents of the prior reservoir 11. In addition to the use of mechanical, electrical and electromechanical means to effect communication between reservoir 11 and sprayer 12, the communication means 600 may be implemented by magnetic means, optical means, sonic means or any other means know to the art capable of communication information.

In another embodiment of the present invention, the communication means 600 between reservoir 11 and sprayer 12 is mixed mechanical and electrical. In such an embodiment, a mechanical element on the reservoir 11 may actuate an electrical element on the sprayer 12 (or vice versa). For example, the reservoir may be provided with at least two, preferably at least three bumps or protrusions (not shown) about the surface 36 of the sleeve 33 of reservoir 11. These bumps or protrusions are positioned to actuate a corresponding mechanically-actuatable element, for example, a micro-switch (shown schematically by reference numeral 632 in FIG. 15B) positioned on the surface 37 of the sleeve 32 of sprayer 12, when the elements are correctly engaged. In this embodiment, the sensor means 632 takes the form of at least two, preferably at least three micro-switches 636. The micro-switches 636 supply inputs to the logic circuit 634 (or in some embodiments, 272) which then decides the action to take based upon the information provided. Thus, if three bumps and corresponding micro-switches are supplied, there will be eight possible discrete data points which can be acted upon by the logic circuit 634. FIG. 15B further schematically show the output of the logic circuit 634 as a series of lamps 638.

In some embodiments of the present invention, the communication means 600 communicates information relating to the liquid contents of the reservoir 11 so that the user may act on the information in a way that optimizes product safety, efficacy, convenience or combinations thereof. The information concerning the liquid may be conveyed to the user/consumer via the sprayer 12 such that the user/consumer is part of the information/feedback loop (i.e. the user can decide how to use the information), or the information may be communicated to the sprayer 12, which directly acts on the information without input from the consumer. For example, the communication means 600 may operate in conjunction with the adjustable nozzle 260 (shown in FIG. 5) to autonomously configure the adjustable nozzle 260 for the safest, most effective or most convenient spray pattern and/or delivery protocol for the particular liquid contained in the reservoir 11.

In a preferred embodiment, the communication means 600 is combined with the quick release coupling system 15 so that the benefits of interchangeability of reservoirs 11 and resultant safety, efficacy, efficiency and cleanliness of dispensing is optimized. However, it is to be noted that the communication means 600 described herein may be advantageously used with a dispensing containers and sprayers having conventional couplings, such as conventional screw threads.

In embodiments incorporating multiple fluid reservoirs, the communication means 600 may include a sensor 632 in each compartment, and provide information which can be used by the logic circuitry 634 to determine the appropriate mixture of each agent contained therein. This may occur based upon preselected criteria, depending upon the contents of each compartment of the reservoir 11, or may include selection means (not shown) allowing the user to adjust proportions or dilution ratios.

In one embodiment of the present invention, the communication means 600 is capable of remembering the prior setting and to advantageous use in preventing sequential use of liquids containing incompatible ingredients. Thus, a reservoir 11 containing bleach may signal such contents to the sprayer 12, and the user is thereby alerted to such ingredient and/or the sprayer 12 is automatically configured for such product. In addition, in a preferred embodiment the communication means are configured such that when the user desires to switch the sprayer 12 to a reservoir 11 containing an ingredient incompatible with one which was registered by the immediately prior setting, the user will be signaled as such whereby the incompatible use will be suspended until the incompatibility can be alleviated. Thus, in the foregoing example, the user may be signaled by means of illumination of a warning light, or a color change indicator or mechanical flag that the subsequent use is incompatible with the prior, or the quick-release coupling system 15 may prevent attachment of the second reservoir 11. In either case, the user may thereby be encouraged to rinse the sprayer 12, whereupon the communication means 600 is reset, or resets itself, or is manually reset by the consumer, and the attachment of the second reservoir 11 is permitted.

In another embodiment of the present invention, the sensor means 632 and logic circuit 634 are capable of analyzing at least one property of the solution in the reservoir 11 such as pH, oxidant level, salinity, ionic strength, viscosity, density, solvent content, optical absorbance, conductivity, color, etc., and provide the user with feedback regarding the use thereof. Such feedback can take the form of, without limitation, instructions, warning, flammability alert, status, and ingredient or active compatibility. Forms of feedback include, without limitation, disabling the sprayer, sounding an alarm, lighting an indicator, or digital or verbal display of status. The communication means 600 may also be utilized to act as a child-safety closure, by for example, requiring a code to be input before permitting dispensing of the contents.

Non-limiting examples of criteria for delivering feedback to the user include: (i) use of an acidic cleaner of pH less than a set threshold; (ii) contraindication on a specific surface (e.g. marble) where a solvent level is higher than a threshold level; (iii) strength of remaining active in solution (e.g. bleach) where strength is critical (such as food surface or disinfectant usage); (iv) subsequent use of a potentially incompatible liquid, such as using an alkaline bleach after use of a highly acidic solution.

In one embodiment of the present invention, the communication means 600 may omit the sensor means 632, and instead use read-only information embedded in a tag integral with the reservoir 11, such as an RFID tag. The information contained in the tag can be used identically to that derived from a sensor, that is, can be used to signal the adjustable nozzle 260 of the sprayer 12 such that the contents of the reservoir 11 are dispensed in an optimal or preferred dispensing pattern, or to drive an aspect of the fluid supply and discharge system 44 as previously described. The RFID tag may also be utilized to supply product information, such as safety information, to the consumer, via the communication means 600 driving a display as the output means 638. The RFID may also provide product efficacy information, such as production date, so that the consumer/user is advised of out-of-date product. Other forms and protocols of short range, low-power wireless telemetry between reservoir 11 and sprayer 12 are suitable, including Bluetooth.

Reservoir/Container

In preferred embodiments of the present invention, the reservoir 11 comprises a bottle, of suitable dimensions to contain the desired amount of fluid to be dispensed. The bottle may be constructed of any material, and typically is a polymer such as polypropylene, polyethylene PET, PVC or styrene-butadiene. The bottle may be constructed of a rigid material, and be free-standing, or could be constructed of a non rigid or semi-rigid material, and not free-standing. In the latter case, the bottle may be foldable, so that its volume can be reduced as the contents are depleted. A non-rigid liner within a rigid bottle is also within the scope of the present invention. The bottle is preferably fitted with a quick-release coupling system 15 as described herein.

In one embodiment of the present invention, the reservoir 11 comprises at least two bottles, or a single bottle with at least one fluid partition to result in at least two fluid compartments, and the sprayer 12 is configured and dimensioned to connect to the single bottle or multiple bottles in the fluid-tight and quick-release manner as herein described. In these embodiments, the fluid compartments contain ingredients selected from actives, carriers, diluents, potentiators, fragrances, aesthetic agents, water and mixtures thereof. The compartments may contain the same or different ingredients. In some embodiments, the compartments may contain ingredients which are normally storage-incompatible, and react when mixed, or which are dissimilar or incompatible or would ordinarily form separate layers or phases if stored together. This allows safe storage and packaging of potentially highly active ingredients which can provide very effective results when combined in use, and safe delivery thereof. For example, a carbonate or bicarbonate plus a surfactant, and an acid may be contained in separate compartments, and used to generate a foam upon dispensing. In a preferred embodiment, the reservoir 11 having multiple chambers with reactive ingredients is used in combination with the communication means as herein described to communicate product information to the user or to operative functions on the sprayer 12.

In a preferred embodiment of the present invention, a multiple chamber reservoir 11 is combined with a sprayer 12 which includes an independent fluid supply and discharge system 44 for each chamber. The fluid supply and discharge system 44 may be manually or electrically powered, as described herein. Alternatively, a fluid supply and discharge system 44 may be employed, with an appropriate valve means (not shown) to meter and/or mix streams from each reservoir chamber. In a particularly preferred embodiment, a multiple chamber reservoir 11 is combined with multiple electrically powered fluid supply and discharge systems 44, and appropriate communication means 600 which permit the user to vary proportions of liquid from each chamber in the resulting spray. The variation can be automatic, based upon product sensor inputs, or manual as desired by the user. A multiple chamber reservoir 11 can be employed to provide simultaneous or sequential dispensing of liquid and gas.

In one embodiment, the present invention may include a filter means (not shown) interposed between the discharge nozzle 17 and the distal end of the dip tube 50. The filter means comprises a structure for housing at least one filtration or treatment medium, and the medium. In embodiments with multiple reservoirs, one of which is water, the filter means may advantageously be positioned to filter the water, thus providing conditioned water for mixing with the active(s) contained in the other reservoir(s). In some embodiments, the filter medium may comprise a porous plug, of a material which will allow gas to pass therethrough but not liquids. Such a filter medium would allow the dispenser 10 of the present invention to dispense gases, including a vapor phase of a liquid contained in the reservoir 11. Such a dispenser system could have utility in fragrance dispensing, for example.

In one embodiment of the present invention wherein the reservoir 11 incorporates an integral dip-tube 50, as shown e.g., in FIG. 13, the internal dip tube 50 fluidically communicates with the piston fluid inlet 48 of the pump 30. Integral dip tube 50 may be a separate component and affixed to an internal wall of the reservoir 11, or it may be an integral component thereof, as by molding. The use of an internal dip tube 50 is particularly preferred when used with a quick-release coupling system 15 of the type having a lateral slide-on mounting, wherein the sprayer 12 is removably attached to the container by sliding the components along the Y or Z axes. The integral dip tube 50 does not have to be coaxial with the fluid infill opening 13, but may be side-mounted as well, provided the fluid path form the dip tube 50 to the piston fluid inlet conduit 48 is continuous. The dip tube 50 may thus be secured to or formed integrally with, a bottle side wall, with a suitable angled or curved fitting (not shown) to provide the fluid communication pathway.

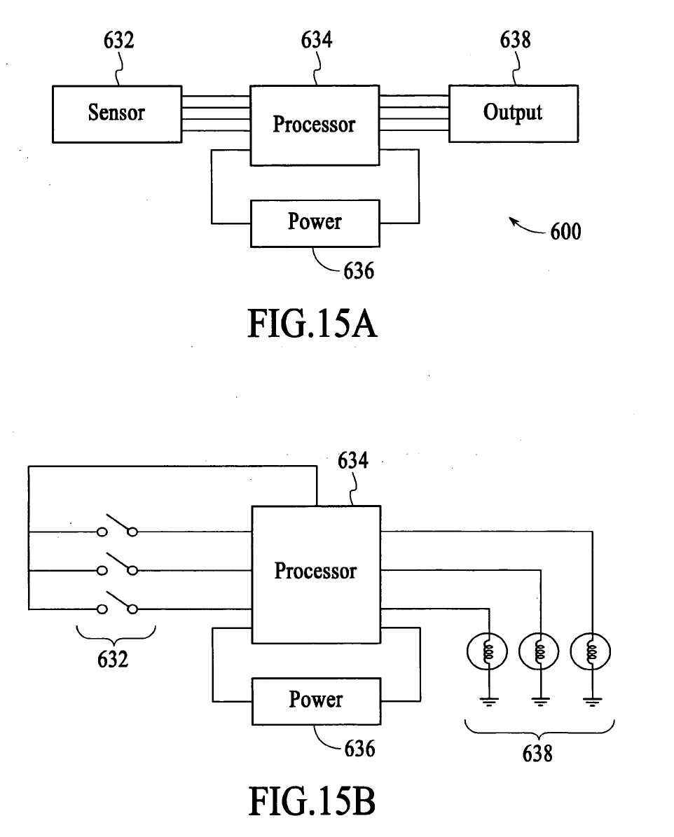

In one embodiment of the dispenser system 10 of the present invention, the dip tube 50 is incorporated into the reservoir 11. In other embodiments, an anti-drip mechanism may be provided such that when the sprayer 12 is transferred from one reservoir 11 to the next, any residual liquid contained in the dip tube 50 will not spill out into the immediate environment, e.g. floor, counter, etc., nor will any such residual liquid contaminate that in the second reservoir 11. Such a mechanism generally comprises a conventional check valve or a drain-back fitting (not shown). FIG. 16 illustrates an embodiment of the present invention wherein an integral dip tube 50 incorporates a re-useable sealing means 750 such that when the sprayer 12 is removed, the reservoir 11 remains sealed. The sealing means 750 includes a ball 752, biased upwardly by a biasing means 754 against a circumferential seat 756. The ball 752 and biasing means 754 are contained within a cage 758 at the top of the dip tube 50. The sprayer 12 is provided with a suitable pin (not shown) such that when the sprayer 12 is engaged to the reservoir 11, the pin urges the ball 752 downwardly from the seat 756, allowing egress of liquid through the appropriate flow path through the sprayer 12 only.

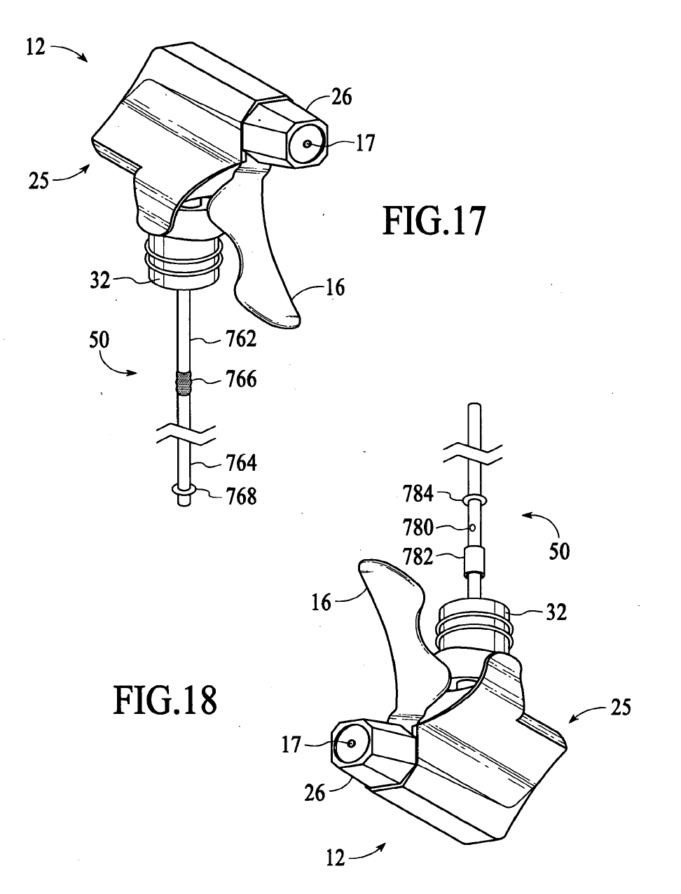

In one embodiment of the present invention, the sprayer 12 and reservoir 11 are capable of dispensing the contents from both an upright and an inverted position. Because liquid or fluid contents are drawn into the fluid supply and delivery system 44 by the dip tube 50, it would be advantageous to include a provision to assure liquid supply when the reservoir 11 is in a partially or fully inverted position. In one embodiment, shown in FIG. 17 a dip tube 50 is provided which comprises a first end 762 in fluid communication with the piston fluid inlet conduit 48 a second end 764 in fluid communication with the liquid contents of the reservoir, and a flexible joint 766, disposed intermediate to the first and second ends. A means for biasing the dip tube 50 with the gravitational force is included, and in a preferred embodiment, comprises a weight 768 attached to or near the tube second end 764. When the reservoir 11 and sprayer 12 are inverted, the weight 768 pulls the dip tube 50 down, which is facilitated by the flexible joint 766. In another embodiment of the present invention, the sprayer 12 and reservoir 11 are capable of dispensing the contents from both an upright and an inverted position by use of separate ports for the piston fluid inlet conduit 48. A conventional dip tube 50 for upright use is thus attached in the conventional manner to the port of the piston fluid inlet conduit 48, while a second short dip tube 50 is also in fluid communication with the piston fluid inlet conduit 48. In use, the user simply selects upright or inverted uses, and a mechanical lever means (not shown) opens the appropriate port and covers the non-selected port.

Referring to FIG. 18, a sprayer 12 of the present invention is shown in an inverted position. The sprayer 12 includes a port 780 in the dip tube 50, located proximal to the piston fluid inlet conduit 48. A cylindrical collar 782 is slidably positioned around the dip tube 50 to cover the port 780 when the sprayer 12 is in an upright position. The collar 782 is restrained from downward movement by a stop 784 on the dip tube 50 below the port 780. When inverted, the collar 782 is free to slide toward the sprayer 12, uncovering the port 780 and permitting the fluid contents of the reservoir 11 to be drawn into the piston fluid supply and discharge system 44.

Materials used to construct or fabricate the components of the liquid dispenser systems of the present invention are any of those known to one of skill in the art to be suitable to implement the particular structure described. Typically, sprayer structural elements and components are formed of a polymeric plastic material, such as polypropylene, polyethylene, PET, PVC or styrene-butadiene, however other materials, including metals may be suitable, and may be preferred for certain components, including conductive elements. Similarly, fabrication methods are any of those know in the art to be suitable, and include molding, injection molding, blow-molding and casting to name a few.

It is to be noted that the dispenser system 10 and/or reservoir 11 of the present invention may be used in modes other than the manual, or hand dispensing of liquids. Thus automatic dispensers, which may have a timed dispensing protocol, or motion or infrared-actuated dispensers may employ the systems, apparatus and methods of the present invention. Additionally, the disclosed manual dispensing systems, apparatus and methods are not limited to dispensing by hand, but may be applicable to other dispensing modes.

While the present invention has been shown and described in accordance with a practical and preferred embodiment thereof, it is recognized that departures from the instant disclosure are contemplated within the spirit of the invention and, therefore, the scope of the invention should not be limited except as defined within the following claims as interpreted under the doctrine of equivalents.

1.-17. (canceled)

18. A fluid dispensing system comprising:
a. a sprayer comprising a sprayer housing, a fluid pump mechanism having a fluid inlet, a fluid outlet and a means for generating a differential pressure between the fluid inlet and fluid outlet, the sprayer further comprising a probe in fluid communication with the fluid inlet and having a piercing element disposed thereon, a fluid dispensing actuator and a fluid dispensing nozzle, the fluid dispensing nozzle defining a first axis;
b. a fluid reservoir, adapted to be in mechanical and fluidic communication with the sprayer, the reservoir having a second axis running therethrough about a nominally vertical dimension thereof, the fluid reservoir including an internal dip tube having a lower end disposed in fluid in the reservoir, and an upper end disposed at an upper surface of the reservoir and having a punctureable seal thereover; and
c. a quick-release coupling system, comprising a first coupling means in mechanical communication with the sprayer, and a second coupling means in mechanical communication with the reservoir, the coupling system adapted to removably engage the sprayer to the fluid reservoir, wherein the coupling system is engaged by a first linear motion, comprising bringing the dispenser body together with the fluid reservoir along said first axis, and wherein said engagement urges said probe downwardly to pierce said seal of said dip tube, resulting in a fluid connection between reservoir and sprayer;
wherein said quick-release coupling system supplies a consumer at least one perceptible signal that the sprayer is secured to the reservoir.

19.-38. (canceled)

39. The fluid dispensing system of claim 18, wherein said signal is selected from the group consisting of visible, audible, tactile and combinations thereof.

40. The fluid dispensing system of claim 39, wherein said audible signal may be produced from by at least a tab and a detent.

41. The fluid dispensing system of claim 39, wherein the visual signal is produced by an indicator light or an indicator flag.

42. The fluid dispensing system of claim 18, wherein said signal is electronically generated.

43. The fluid dispensing system of claim 18, wherein when two portions of the quick-releasing coupling system are locked, a plurality of primary colored elements align to create a secondary color.

44. The fluid dispensing system of claim 18, wherein the quick-releasing coupling system may further comprise a ferrule and a ferrule seat.

45. The fluid dispensing system of claim 18, wherein the quick-releasing coupling system may further comprise at least one gasket.

46. The fluid dispensing system of claim 18, wherein the fluid dispensed is selected from liquids, vapor phases of liquids, gases and mixtures thereof.

47. A fluid dispensing system comprising:
a. a sprayer comprising a sprayer housing, a fluid pump mechanism having a fluid inlet, a fluid outlet and a means for generating a differential pressure between the fluid inlet and fluid outlet, the sprayer further comprising a probe in fluid communication with the fluid inlet and having a piercing element disposed thereon, a fluid dispensing actuator and a fluid dispensing nozzle, the fluid dispensing nozzle defining a first axis;
b. a fluid reservoir, adapted to be in mechanical and fluidic communication with the sprayer, the reservoir having a second axis running therethrough about a nominally vertical dimension thereof, the fluid reservoir including an internal dip tube having a lower end disposed in fluid in the reservoir, and an upper end disposed at an upper surface of the reservoir and having a punctureable seal thereover;
c. a quick-release coupling system, comprising a first coupling means in mechanical communication with the sprayer, and a second coupling means in mechanical communication with the reservoir, the coupling system adapted to removably engage the sprayer to the fluid reservoir, wherein the coupling system is engaged by a first linear motion, comprising bringing the dispenser body together with the fluid reservoir along said first axis, and wherein said engagement urges said probe downwardly to pierce said seal of said dip tube, resulting in a fluid connection between reservoir and sprayer; and
d. a communication means for communicating information of a liquid contained in the fluid reservoir to a display means on the sprayer, or to an operative element on the sprayer, the operative element comprising an adjustable nozzle.

48. The fluid dispensing system of claim 47, wherein the information can be encoded in a plurality of signaling structures on the reservoir and the encoded information is read by a plurality of corresponding receiving structures on the sprayer.

49. The fluid dispensing system of claim 47, wherein the communication means may provide a binary code which can be input to a logic circuit of the adjustable nozzle.

50. The fluid dispensing system of claim 47, wherein the communication means may comprise at least one user-detectable flag which is revealed to convey the information to a user.

51. The fluid dispensing system of claim 47, wherein the information indicates expiration or near-expiration of product efficacy or empty or near-empty status of the reservoir.

52. The fluid dispensing system of claim 47, wherein the quick-releasing coupling system may include a ferrule and a ferrule seat.

53. The fluid dispensing system of claim 47, wherein the quick-releasing coupling system may include at least one gasket.

54. A hand-held trigger-actuated pump sprayer combination comprising:
a. a sprayer comprising a pair of sidewalls, a top wall that blends into a rear wall, a lower surface, a nozzle cap and a pivoted trigger disposed onto a front end of the sprayer, wherein said pivoted trigger is operatively connected by an arm to a piston;
b. a fluid reservoir, adapted to be in mechanical and fluidic communication with the sprayer, the reservoir having a second axis running therethrough about a nominally vertical dimension thereof, the fluid reservoir including an internal dip tube having a lower end disposed in fluid in the reservoir, and an upper end disposed at an upper surface of the reservoir;
c. a quick-release coupling system, comprising a first coupling means in mechanical communication with the sprayer, and a second coupling means in mechanical communication with the reservoir, the coupling system adapted to removably engage the sprayer to the fluid reservoir, wherein the coupling system is engaged by a first linear motion, comprising bringing the dispenser body together with the fluid reservoir along said first axis, and wherein said engagement urges said probe downwardly to create a fluid pathway with the dip tube, resulting in a fluid connection between reservoir and sprayer; and
d. a communication means for communicating information of a liquid contained in the fluid reservoir to a display means on the sprayer, or to an operative element on the sprayer, the operative element comprising an adjustable nozzle.
